(19) United States
(12) Patent Application Publication
(10) Pub. No.: US 2013/0084510 A1
(43) Pub. Date: Apr. 4, 2013

(54) FUEL CELL SYSTEM, CONTROL METHOD FOR FUEL CELL SYSTEM, AND DEGRADATION DETERMINING METHOD FOR FUEL CELL STACK

(71) Applicants: Takatoshi Masui, Mishima-shi (JP); Takashi Ono, Kirishima-shi (JP); Katsuki Higaki, Kitakatsuragi-gun (JP); Minoru Suzuki, Suita-shi (JP)

(72) Inventors: Takatoshi Masui, Mishima-shi (JP); Takashi Ono, Kirishima-shi (JP); Katsuki Higaki, Kitakatsuragi-gun (JP); Minoru Suzuki, Suita-shi (JP)

(73) Assignees: KYOCERA CORPORATION, Kyoto-shi (JP); TOYOTA JIDOSHA KABUSHIKI KAISHA, Toyota-shi (JP)

(21) Appl. No.: 13/699,986

(22) PCT Filed: May 27, 2011
(86) PCT No.: PCT/IB11/01549

§ 371 Date: Nov. 26, 2012

(30) Foreign Application Priority Data
May 27, 2010 (JP) 2010-122113

(51) Int. Cl. H01M 8/04

(52) U.S. Cl. CPC H01M 8/04619; H01M 8/0494
USPC 429/423; 429/430; 429/431; 429/432

(57) ABSTRACT

A fuel cell system includes: a fuel cell stack that is formed of a plurality of serially connected fuel-cell cells that use fuel gas and oxidant gas to generate electric power; a detecting unit that detects an output power generated by each of a first fuel-cell cell group and a second fuel-cell cell group that are grouped on the basis of a power generation performance factor; and an operating condition changing unit that changes an operating condition of the fuel-cell cells on the basis of a rate of deviation between the generated output power of the first fuel-cell cell group, detected by the detecting unit, and the generated output power of the second fuel-cell cell group, detected by the detecting unit.

### BACKGROUND OF THE INVENTION

1. Field of the Invention

The invention relates to a fuel cell system, a control method for a fuel cell system and a degradation determining method for a fuel cell stack.

2. Description of Related Art

A fuel cell is generally a device that uses hydrogen and oxygen as fuel to gain electrical energy. The fuel cell is environmentally excellent and is able to achieve high energy efficiency, so development of the fuel cell has been widely pursued as a future energy supply system.

The fuel cell may degrade as it continues generating electric power. It is difficult to determine from its appearance whether the fuel cell has degraded, so it is desirable to be able to determine whether the fuel cell has degraded on the basis of the output power of the fuel cell. For example, Japanese Patent Application Publication No. 62-271357 (JP-A-62-271357) describes a cell damage detection system. The cell damage detection system detects and compares the voltage and/or current of each stack to detect damage to cells that constitute each stack.

However, in the technique described in JP-A-62-271357, no criterion of grouping stacks is defined, so it is difficult to detect degradation of a stack if abnormal cells are scattered. In addition, even when a stack includes an abnormal cell, it may be determined to be normal.

### SUMMARY OF THE INVENTION

The invention provides a fuel cell system, a control method for a fuel cell system and a degradation determining method for a fuel cell stack that are able to easily determine whether a fuel cell stack has degraded.

A first aspect of the invention provides a fuel cell system. The fuel cell system includes: a fuel cell stack that is formed of a plurality of serially connected fuel-cell cells that use fuel gas and oxidant gas to generate electric power; a detecting unit that detects an output power generated by each of a first fuel-cell cell group and a second fuel-cell cell group that are grouped on the basis of a power generation performance factor; and an operating condition changing unit that changes an operating condition of the fuel-cell cells on the basis of a rate of deviation between the generated output power of the first fuel-cell cell group, detected by the detecting unit, and the generated output power of the second fuel-cell cell group, detected by the detecting unit. With the above aspect, it is possible to simply determine whether the fuel cell stack has degraded. In addition, it is possible to set an appropriate operating condition in response to degradation of the fuel cell stack.

In the above aspect, the operating condition changing unit may change the operating condition of the fuel-cell cells when the rate of deviation is higher than or equal to a predetermined value. In addition, the predetermined value may increase as an output power generated by the fuel cell stack increases. Furthermore, a temperature of the fuel-cell cells may be used as the power generation performance factor, and the first fuel-cell cell group may be relatively low in temperature as compared to the second fuel-cell cell group.

In the above aspect, a flow rate of oxidant gas supplied to the fuel-cell cells may be used as the power generation performance factor, and the first fuel-cell cell group may be relatively low in the flow rate of oxidant gas as compared to the second fuel-cell cell group. In addition, the generated output power may be at least any one of a generated electric power, a generated current and a generated voltage.

In the above aspect, the operating condition changing unit may decrease a rated output power of the fuel-cell cells when the rate of deviation is higher than or equal to a predetermined value. In addition, the fuel cell system may further include a combustion chamber that burns fuel offgas exhausted from the fuel cell stack to heat the fuel cell stack, wherein the operating condition changing unit may increase an amount of fuel gas supplied to the fuel-cell cells when the rate of deviation is higher than or equal to a predetermined value.

In the above aspect, the fuel cell system may include a reformer that produces the fuel gas by causing steam reforming reaction between reforming water and raw fuel, and the fuel cell stack may be arranged along the reformer, the first fuel-cell cell group may be arranged adjacent to a reforming water inlet of the reformer, and the second fuel-cell cell group may be arranged adjacent to a fuel gas outlet of the reformer with respect to the first fuel-cell cell group.

In the above aspect, the first fuel-cell cell group and the second fuel-cell cell group may be arranged parallel to each other, and the reformer may extend in a stacking direction of the first fuel-cell cell group, may turn back and may extend in a stacking direction of the second fuel-cell cell group.

A second aspect of the invention provides a fuel cell system. The fuel cell system includes: a fuel cell stack that is formed of a plurality of serially connected fuel-cell cells that use fuel gas and oxidant gas to generate electric power; a detecting unit that detects an output power generated by each of a first fuel-cell cell group and a second fuel-cell cell group that are grouped on the basis of a power generation performance factor; and a degradation determining unit that determines whether the fuel cell stack has degraded on the basis of a rate of deviation between the generated output power of the first fuel-cell cell, group, detected by the detecting unit, and the generated output power of the second fuel-cell cell group, detected by the detecting unit. With the above aspect, it is possible to simply determine whether the fuel cell stack has degraded. The fuel cell system may further include an information unit that, when the degradation determining unit determines that the fuel cell stack has degraded, informs a user of information about the degradation.

A third aspect of the invention provides a control method for a fuel cell system that includes a fuel cell stack formed of a plurality of serially connected fuel-cell cells that use fuel gas and oxidant gas to generate electric power. The control method includes: detecting an output power generated by each of a first fuel-cell cell group and a second fuel-cell cell group that are grouped on the basis of a power generation performance factor; and changing an operating condition of the fuel-cell cells on the basis of a rate of deviation between the detected generated output power of the first fuel-cell cell group and the detected generated output power of the second fuel-cell cell group. With the above aspect, it is possible to simply determine whether the fuel cell stack has degraded. In addition, it is possible to set an appropriate operating condition in response to degradation of the fuel cell stack.

In the above aspect, the operating condition of the fuel-cell cells may be changed when the rate of deviation is higher than or equal to a predetermined value. In addition, the predetermined value may increase as an output power generated by the fuel cell stack increases. Furthermore, a temperature of the fuel-cell cells may be used as the power generation performance factor, and the first fuel-cell cell group may be relatively low in temperature as compared to the second fuel-cell cell.

In the above aspect, a flow rate of oxidant gas supplied to the fuel-cell cells may be used as the power generation performance factor, and the first fuel-cell cell group may be relatively low in the flow rate of oxidant gas as compared to the second fuel-cell cell group. In addition, the generated output power may be at least any one of a generated electric power, a generated current and a generated voltage.

In the above aspect, a rated output power of the fuel-cell cells may be decreased when the rate of deviation is higher than or equal to a predetermined value. In addition, fuel offgas exhausted from the fuel cell stack may be burned to heat the fuel cell stack, and an amount of fuel gas supplied to the fuel-cell cells may be increased when the rate of deviation is higher than or equal to a predetermined value.

In the above aspect, the fuel cell system may include a reformer that produces the fuel gas by causing steam reforming reaction between reforming water and raw fuel, and the fuel cell stack may be arranged along the reformer, the first fuel-cell cell group may be arranged adjacent to a reforming water inlet of the reformer, and the second fuel-cell cell group may be arranged adjacent to a fuel gas outlet of the reformer with respect to the first fuel-cell cell group.

In the above aspect, the first fuel-cell cell group and the second fuel-cell cell group may be arranged parallel to each other, and the reformer may extend in a stacking direction of the first fuel-cell cell group, may turn back and may extend in a stacking direction of the second fuel-cell cell group.

A fourth aspect of the invention provides a degradation determining method for a fuel, cell stack formed of a plurality of serially connected fuel-cell cells that use fuel gas and oxidant gas to generate electric power. The degradation determining method includes: detecting an output power generated by each of a first fuel-cell cell group and a second fuel-cell cell group that are grouped on the basis of a power generation performance factor; and determining whether the fuel cell stack has degraded on the basis of a rate of deviation between the detected generated output power of the first fuel-cell cell group and the detected generated output power of the second fuel-cell cell group. With the above aspect, it is possible to simply determine whether the fuel cell stack has degraded. The degradation determining method may further include: when it is determined that the fuel cell stack has degraded, informing a user of information about the degradation.

With the above aspects, it is possible to provide a fuel cell system, a control method for a fuel cell system and a degradation determining method for a fuel cell stack that are able to easily determine whether a fuel cell stack has degraded.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the overall configuration of a fuel cell system according to a first embodiment;

FIG. 2 is a partially perspective view of a fuel-cell cell, including its cross sectional view, according to the first embodiment;

FIG. 3 is a perspective view for illustrating a fuel cell stack of a fuel cell stack system according to the first embodiment;

FIG. 4A is a perspective view that shows the overall configuration of the fuel cell stack system according to the first embodiment;

FIG. 4B is a perspective view that shows an extracted oxidant gas introducing member shown in FIG. 4A;

FIG. 4C is a partially perspective view for illustrating a reformer according to the first embodiment;

FIG. 5A is a perspective view that shows the overall configuration of the fuel cell stack system according to the first embodiment;

FIG. 5B is a view of the arrangement of an A-row fuel cell stack and a B-row fuel cell stack according to the first embodiment when viewed from the side of the reformer;

FIG. 5C is a graph that shows the temperatures of the respective fuel cell stacks according to the first embodiment;

FIG. 6 is a graph that shows the correlation between the temperature of the fuel cell stack and the temperature of an electrolyte according to the first embodiment;

FIG. 7A is a graph that shows the correlation between the current generated by each fuel cell stack and the voltage generated by each fuel cell stack and the correlation between the generated current and the electric power generated by each fuel cell stack according to the first embodiment;

FIG. 7B is a partially enlarged graph of FIG. 7A;

FIG. 8A is a graph that shows the electric power generated by the initial fuel cell stacks over time according to the first embodiment;

FIG. 8B is a graph that shows the electric power generated by the degraded fuel cell stacks over time according to the first embodiment;

FIG. 9 is a view that shows an example of the flowchart executed when it is determined whether the fuel cell stack according to the first embodiment has degraded;

FIG. 10A to FIG. 10C are views that show examples of grouping of a first fuel-cell cell group and a second fuel-cell cell group according to the first embodiment;

FIG. 11A is a graph that shows the calculated results of the correlation between the temperature and the flow rate of fuel gas in each fuel cell stack according to the first embodiment;

FIG. 11B is a view that shows an example of grouping of a first fuel-cell cell group and a second fuel-cell cell group according to the first embodiment;

FIG. 12A is a graph that shows the calculated results of the flow rate of oxidant gas when rated power generation and minimum power generation are performed in the fuel cell stacks according to the first embodiment;

FIG. 12B and FIG. 12C are views that show examples of grouping of a first fuel-cell cell group and a second fuel-cell cell group according to the first embodiment;

FIG. 13 is a block diagram that shows the overall configuration of a fuel cell system according to a second embodiment; and

FIG. 14 is a view that shows an example of the flowchart executed when it is determined whether the fuel cell stack according to the second embodiment has degraded.

### DETAILED DESCRIPTION OF EMBODIMENTS

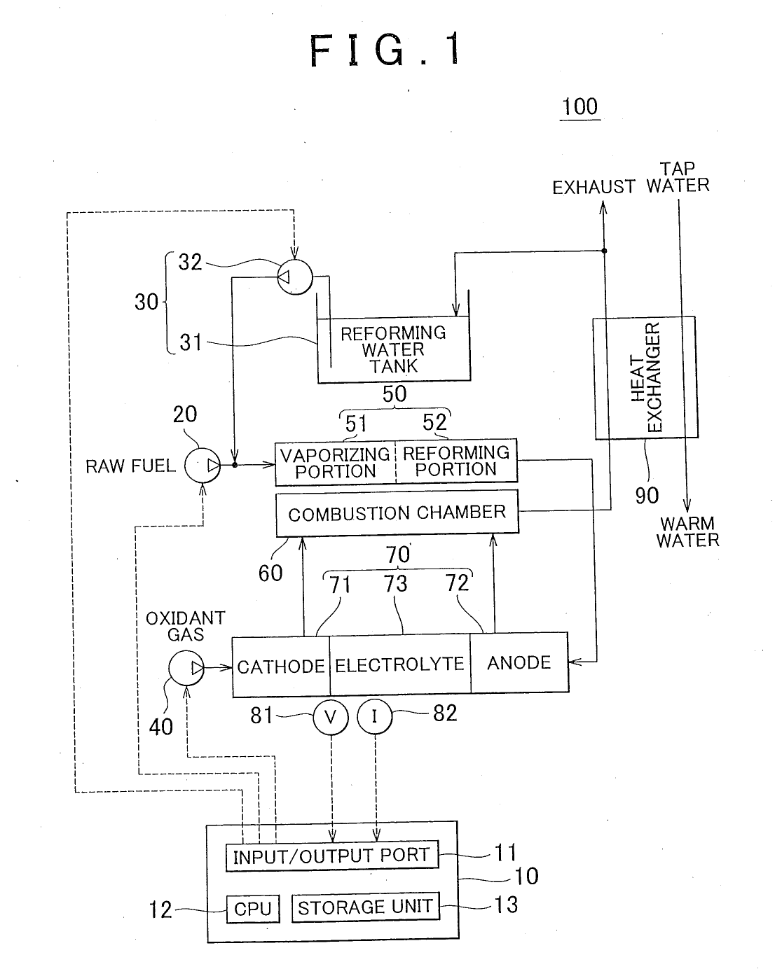

A first embodiment of the invention will be described. FIG. 1 is a block diagram that shows the overall configuration of a fuel cell system 100 according to the first embodiment. As shown in FIG. 1, the fuel cell system 100 includes a control unit 10, a raw fuel supply portion 20, a reforming water supply portion 30, an oxidant gas supply portion 40, a reformer 50, a combustion chamber 60, a fuel cell stack system 70 and a heat exchanger 90. In addition, the fuel cell system 100 includes a voltage sensor 81 and a current sensor 82 as sensor units.

The control unit 10 is formed of a central processing unit (CPU), a read only memory (ROM), a random access memory (RAM), an interface, and the like. The control unit 10 includes an input/output port 11, a CPU 12, a storage unit 13, and the like. The input/output port 11 is an interface between the control unit 10 and various devices. The storage unit 13 is a memory that includes a ROM, a RAM, and the like. The ROM stores programs executed by the CPU 12. The RAM stores variables, and the like, used in processing.

The raw fuel supply portion 20 includes a fuel pump, and, the like, for supplying the reformer 50 with raw fuel, such as hydrocarbon. The reforming water supply portion 30 includes a reforming water tank 31, a reforming water pump 32, and the like. The reforming water tank 31 stores reforming water required of steam reforming reaction in the reformer 50. The reforming water pump 32 is used to supply the reformer 50 with reforming water stored in the reforming water tank 31. The oxidant gas supply portion 40 includes an air pump, and the like. The air pump is used to supply oxidant gas, such as air, to the cathodes 71 of the fuel cell stack system 70. The reformer 50 includes a vaporizing portion 51 and a reforming portion 52. The vaporizing portion 51 is used to vaporize reforming water. The reforming portion 52 is used to produce fuel gas by steam reforming reaction. The fuel cell stack system 70 includes a fuel cell stack in which a plurality of fuel-cell cells are stacked. In each of the fuel-cell cells, an electrolyte 73 is sandwiched by the cathode 71 and the anode 72.

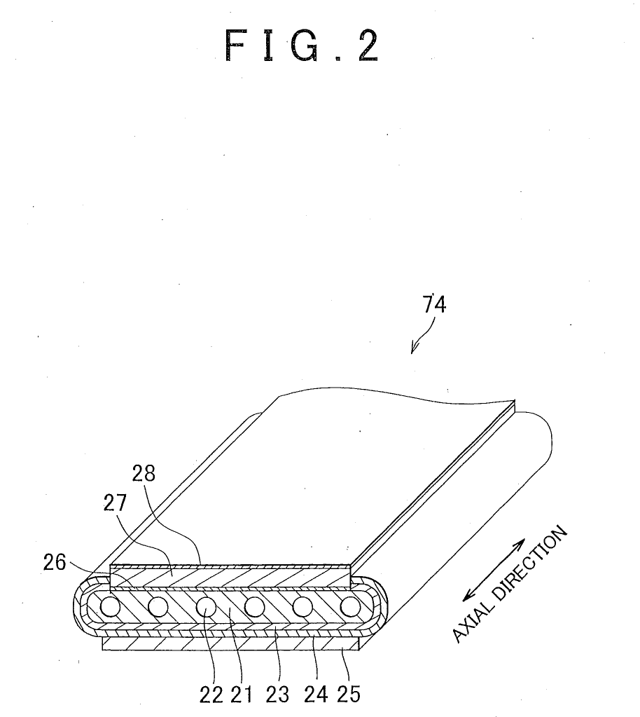

FIG. 2 is a partially perspective view of each fuel-cell cell 74, including its cross sectional view, that constitutes the fuel cell stack of the fuel cell stack system 70. As shown in FIG. 2, each fuel-cell cell 74 has a flat columnar shape as a whole. A plurality of gas passages 22 are formed inside a conductive support 21. The conductive support 21 has a gas permeability. The plurality of fuel gas passages 22 extend in the axial direction (longitudinal direction) of the conductive support 21. A fuel electrode 23, a solid electrolyte 24 and an oxygen electrode 25 are laminated on one of the flat surfaces of the outer peripheral surface of the conductive support 21 in the stated order. An interconnector 27 is provided on the other one of the flat surfaces, facing the oxygen electrode 25, via a joining layer 26, and a p-type semiconductor layer 28 for reducing contact resistance is provided on the interconnector 27. The fuel electrode 23 functions as the anode 72 shown in FIG. 1. The oxygen electrode 25 functions as the cathode 71 shown in FIG. 1. The solid electrolyte 24 functions as the electrolyte 73 shown in FIG. 1.

As fuel gas containing hydrogen is supplied to the fuel gas passages 22, hydrogen is supplied to the fuel electrode 23. On the other hand, as oxidant gas containing oxygen is supplied to around the fuel-cell cell 74, oxygen is supplied to the oxygen electrode 25. By so doing, the following electrode reactions occur in the oxygen electrode 25 and in the fuel electrode 23 to generate electric power. Power generation reaction is performed, for example, at 600° C. to 1000° C.

Oxygen Electrode: 1/2O₂+2e⁻→O²⁻ (solid electrolyte)

Fuel Electrode: O²⁻ (solid electrolyte)+H₂→H₂O+2e⁻

The material of the oxygen electrode 25 has an oxidation resistance, and is porous so that gaseous oxygen can reach the interface between the oxygen electrode 25 and the solid electrolyte 24. The solid electrolyte 24 has the function of transferring oxygen ions O²⁻ from the oxygen electrode 25 to the fuel electrode 23. The solid electrolyte 24 is formed of an oxygen ion conducting oxide. In addition, the solid electrolyte 24 is stable in an oxidation/reduction atmosphere and is dense in order to physically isolate fuel gas and oxidant gas from each other. The fuel electrode 23 is made of a material that is stable in a reduction atmosphere and that has an affinity for hydrogen. The interconnector 27 is provided in order to electrically connect the fuel-cell cells 74 in series with each other. The interconnector 27 is dense in order to physically isolate fuel gas and oxidant gas from each other.

For example, the oxygen electrode 25 is made of a lanthanum cobaltite-based perovskite composite oxide, or the like, of which both electrons and ions have a high conductivity. The solid electrolyte 24 is made of, for example, ZrO₂ (YSZ) that contains Y₂O₃ having a high ion conductivity. The fuel electrode 23 is made of, for example, a mixture of Ni having a high electron conductivity and ZrO₂ (YSZ) containing Y₂O₃. The interconnector 27 is made of, for example, LaCrO₃ that has a high electron conductivity and in which an alkaline-earth oxide is dissolved in a solid state. These materials desirably have close thermal expansion coefficients.

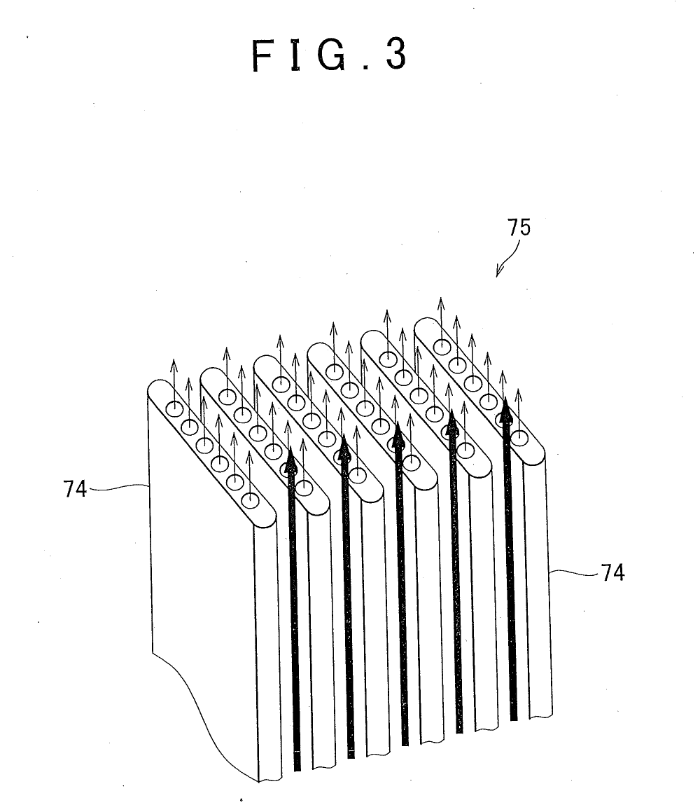

FIG. 3 is a perspective view for illustrating a fuel cell stack 75 of the fuel cell stack system 70. In the fuel cell stack 75, a plurality of the fuel-cell cells 74 are stacked one on top of another via a current collecting member. Each fuel-cell cell 74 is stacked so that the fuel electrode 23 faces the oxygen electrode 25. Note that, in FIG. 3, the narrow arrows indicate the flow of fuel gas, and the wide arrows indicate the flow of oxidant gas.

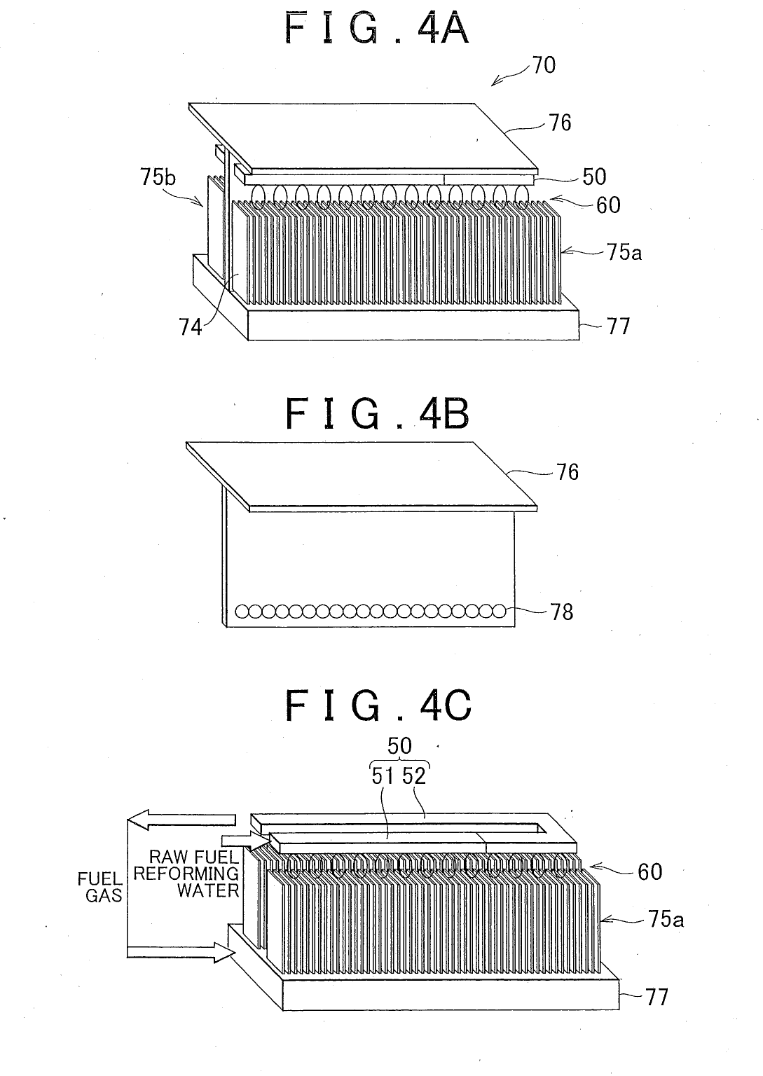

FIG. 4A is a perspective view that shows the overall configuration of the fuel cell stack system 70. FIG. 4B is a perspective view that shows an extracted oxidant gas introducing member 76 of the fuel cell stack system 70 shown in FIG. 4A. As shown in FIG. 4A, in the fuel cell stack system 70, a pair of fuel cell stacks 75a and 75b (fuel-cell cells 74) are arranged on a manifold 77 so that the respective stacking directions are substantially parallel to each other. Each of the fuel cell stacks 75a and 75b has a plurality of the stacked solid oxide fuel-cell cells 74.

The manifold 77 shown in FIG. 4A has holes that are in fluid communication with the fuel gas passages 22 of the respective fuel-cell cells 74. By so doing, fuel gas flowing through the manifold 77 flows into the fuel gas passages 22. The reformer 50 is arranged on the opposite side of the fuel cell stacks 75a and 75b with respect to the manifold 77. For example, the reformer 50 extends in the stacking direction of one of the fuel cell stacks, turns back at one end, and then extends in the stacking direction of the other one of the fuel cell stacks. In the present embodiment, the fuel cell stack 75a is arranged adjacent to the reforming water inlet side of the reformer 50, and the fuel cell stack 75b is arranged adjacent to the fuel gas outlet side of the reformer 50.

In addition, as shown in FIG. 4B, the oxidant gas introducing member 76 is arranged between the fuel cell stack 75a and the fuel cell stack 75b. The oxidant gas introducing member 76 has space for allowing oxidant gas to flow. Holes 78 are formed at an end portion of the oxidant gas introducing member 76 adjacent to the manifold 77. By so doing, oxidant gas flows outside the fuel-cell cells 74. Fuel gas flows through the fuel gas passages 22 of the fuel-cell cells 74 and oxidant gas flows outside the fuel-cell cells 74 to thereby generate electric power in the fuel-cell cells 74.

Fuel gas that has been subjected to power generation in the fuel-cell cells 74 (fuel offgas) and oxidant gas that has been subjected to power generation (oxidant offgas) meet at end portions of the respective fuel-cell cells 74, opposite to the manifold 77. Fuel offgas contains inflammables, such as unburned hydrogen, so fuel offgas burns using oxygen contained in oxidant offgas. In this embodiment, the combustion chamber 60 is a space in which fuel offgas burns between upper ends of the fuel-cell cells 74 (fuel cell stacks 75a and 75b) and the reformer 50.

The upstream side of the reformer 50 functions as the vaporizing portion 51, and the downstream side of the reformer 50 functions as the reforming portion 52. As shown in FIG. 4C, as raw fuel, such as hydrocarbon, and reforming water are supplied to the reformer 50, reforming water vaporizes in the vaporizing portion 51 to generate steam and then the generated steam is mixed with raw fuel, such as hydrocarbon. In the reforming portion 52, steam and raw fuel, such as hydrocarbon, cause steam reforming reaction via a catalyst to produce fuel gas.

Subsequently, the outline of operation during power generation of the fuel cell system 100 will be described with reference to FIG. 1. The raw fuel supply portion 20 supplies a required amount of raw fuel to the reformer 50 in accordance with a command from the control unit 10. The reforming water pump 32 supplies a required amount of reforming water to the reformer 50 in accordance with a command from the control unit 10. Reforming water utilizes heat of combustion in the combustion chamber 60 to vaporize in the vaporizing portion 51 to thereby become steam. In the reforming portion 52, steam reforming reaction that utilizes heat of combustion in the combustion chamber 60 occurs. By so doing, fuel gas containing hydrogen is produced in the reforming portion 52. Fuel gas produced in the reforming portion 52 is supplied to the anodes 72.

The oxidant gas supply portion 40 supplies a required amount of oxidant gas to the cathodes 71 in accordance with a command from the control unit 10. By so doing, electric power is generated in the fuel cell stack system 70. Oxidant offgas exhausted from the cathodes 71 and fuel offgas exhausted from the anodes 72 flow into the combustion chamber 60. In the combustion chamber 60, fuel offgas burns using oxygen contained in oxidant offgas. Heat obtained through burning is transferred to the reformer 50 and the fuel cell stack system 70 (fuel cell stacks 75a and 75b). In this way, in the fuel cell system 100, inflammable components, such as hydrogen and carbon dioxide, contained in fuel offgas may be burned in the combustion chamber 60. The heat exchanger 90 exchanges heat between exhaust gas exhausted from the combustion chamber 60 and tap water flowing in the heat exchanger 90. Condensed water obtained from exhaust gas through heat exchange is stored in the reforming water tank 31.

The voltage sensor 81 detects the voltage generated by a group of one or more successive fuel-cell cells 74 (first fuel-cell cell group) of the fuel cell stack system 70 and the other group of one or more successive fuel-cell cells 74 (second fuel-cell cell group) of the fuel cell stack system 70, and then transmits the detected results to the control unit 10. The current sensor 82 detects the current generated by the fuel cell stack system 70, and then transmits the detected result to the control unit 10.

The control unit 10 determines whether the fuel cell stack system 70 has degraded on the basis of the detected results of the sensors, and then changes the operating condition of the fuel cell stack system 70 on the basis of the determined result. Thus, the control unit 10 functions as an operating condition changing unit. Hereinafter, determination as to whether the fuel cell stack system 70 has degraded will be described. Note that a situation that the fuel cell stack system 70 has degraded means that, for example, a member that constitutes the fuel-cell cell 74 deteriorates over time.

When the performance of the fuel cell stack 75 is good, variations in power generation performance factor, such as the temperature of the fuel cell stack 75, the oxygen partial pressure in each fuel-cell cell 74 and the hydrogen partial pressure in each fuel-cell cell 74, are absorbed to achieve intended power generation performance. However, as the degradation of the fuel cell stack 75 advances, intended power generation performance may not be gained when variations in power generation performance factor occurs. It is possible to determine whether the fuel cell stack 75 has degraded using the above phenomenon.

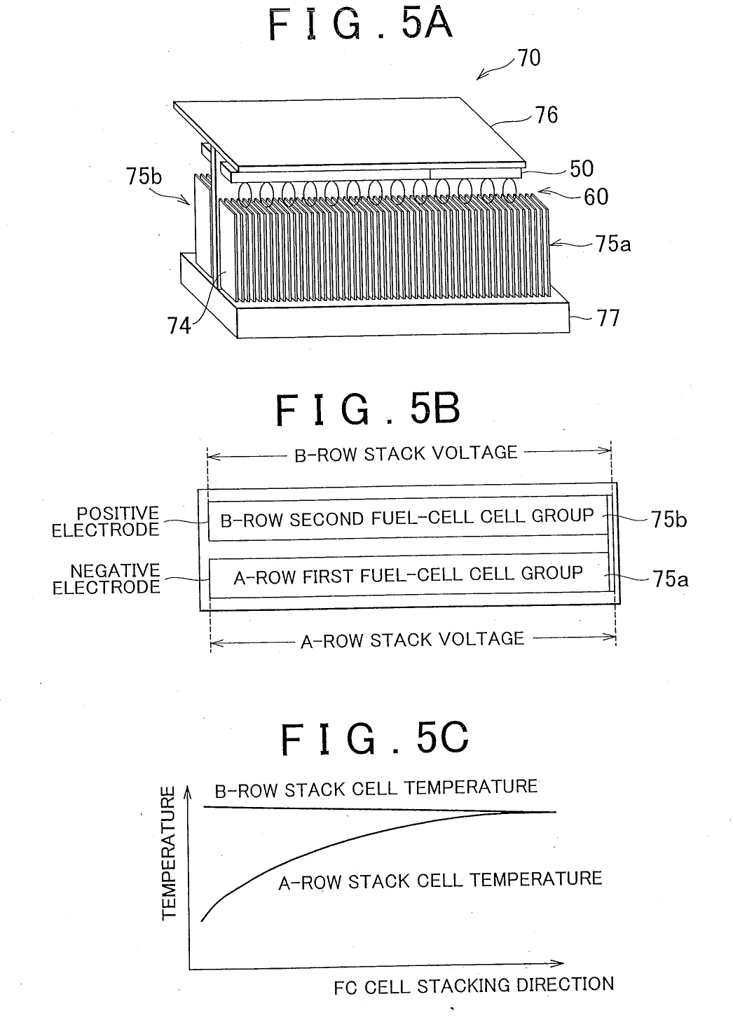

First, the degradation of the fuel cell stack 75 will be described focusing on the temperature as an example of the power generation performance factor. FIG. 5A is a perspective view that shows the overall configuration of the fuel cell stack system 70. FIG. 5B is a view of the arrangement of the A-row fuel cell stack 75a (first fuel-cell cell group) and the B-row fuel cell stack 75b (second fuel-cell cell group) when viewed from the side of the reformer 50. The reforming water inlet side end of the fuel cell stack 75a functions as a negative electrode. The other end side of the fuel cell stack 75a is connected to the fuel cell stack 75b. The fuel gas outlet side end of the fuel cell stack 75b functions as a positive electrode.

FIG. 5C is a graph that shows the temperatures of the respective fuel cell stacks 75a and 75b. Note that the abscissa axis of FIG. 5C represents the cell stacking direction of each of the fuel cell stacks 75a and 75b. In FIG. 5C, the left side of the abscissa axis indicates the reforming water inlet side of the vaporizing portion 51, and the right side of the abscissa axis indicates a side toward which reforming water flows. Reforming water vaporizes in the vaporizing portion 51, so the temperature of the vaporizing portion 51 is lower than the temperature of the reforming portion 52. Thus, the temperature of the fuel cell stack 75a is lower than the temperature of the fuel cell stack 75b. Note that it is also applicable that thermometers that respectively measure the temperature of the fuel cell stack 75a and the temperature of the fuel cell stack 75b are used to measure the temperature of the fuel cell stack 75a and the temperature of the fuel cell stack 75b.

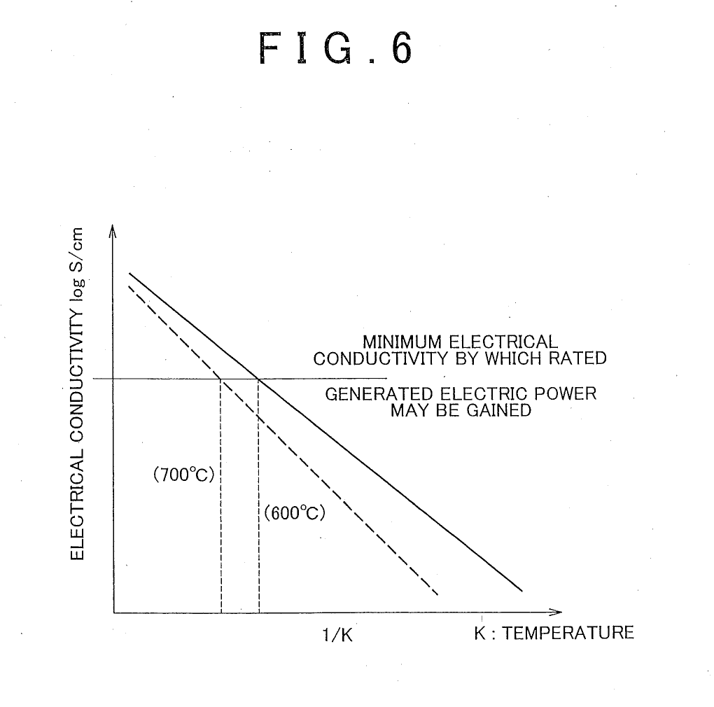

On the other hand, the electrical conductivity of the electrolyte, which is a direct function of the power generation performance of the fuel cell stack, closely correlates with the temperature of the fuel cell stack. FIG. 6 is a view that shows the correlation between the temperature of the fuel cell stack and the temperature of the electrolyte. The solid line in FIG. 6 shows the correlation between the temperature of the normal fuel cell stack and the electrical conductivity of the electrolyte. As shown by the solid line in FIG. 6, as the temperature of the fuel cell stack decreases, the electrical conductivity of the electrolyte decreases. Thus, the power generation performance of the fuel cell stack decreases. On the other hand, as the temperature of the fuel cell stack increases, the electrical conductivity of the electrolyte increases. Thus, the power generation performance of the fuel cell stack improves. In the normal fuel cell stack, the high electrical conductivity of the electrolyte is maintained, so a rated generated electric power may also be gained at relatively low temperatures. In the example of FIG. 6, a rated generated electric power is gained at a relatively low temperature of 600° C.

However, with a lapse of power generation time of the fuel cell stack, the fuel cell stack may degrade because of alteration, blockage, or the like, of a reaction site of the electrolyte. In this case, for example, as indicated by the broken line in FIG. 6, the temperature for obtaining the rated generated electric power increases. In the example shown by the broken line in FIG. 6, the rated generated electric power is not gained until 700° C. As the degradation of the fuel cell stack advances, the temperature at which the rated generated electric power is gained further increases.

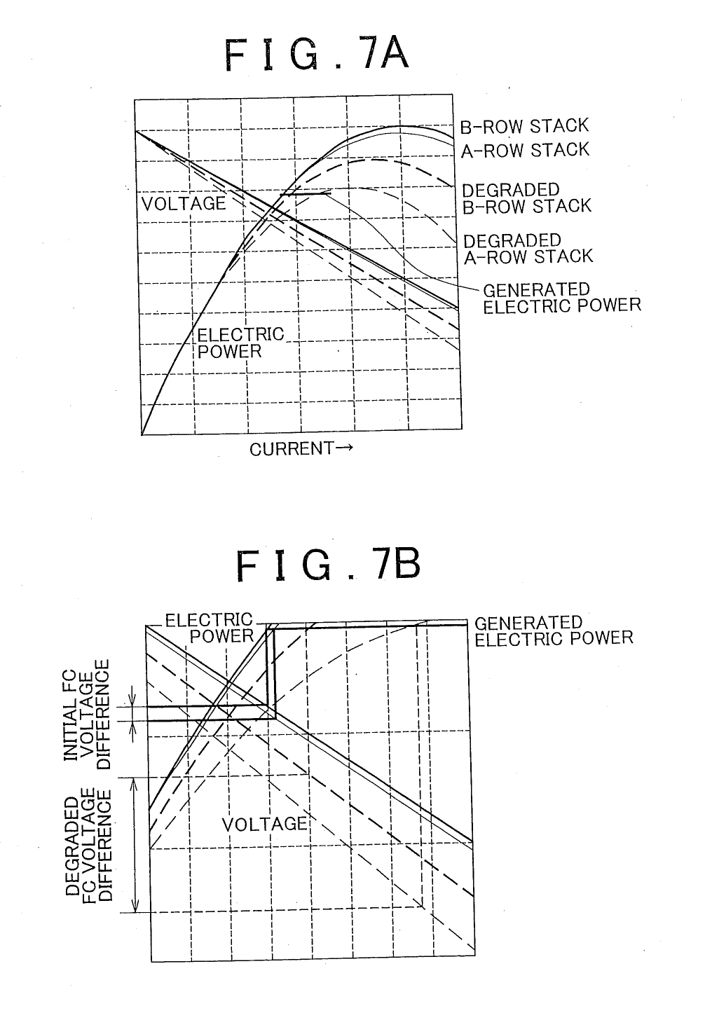

FIG. 7A is a graph that shows the correlation between the current generated by each of the fuel cell stacks 75a and 75b and the voltage generated by each of the fuel cell stacks 75a and 75b and the correlation between the current generated by each of the fuel cell stacks 75a and 75b and the electric power generated by each of the fuel cell stacks 75a and 75b. FIG. 7B is a partially enlarged graph of FIG. 7A. In FIG. 7A, the narrow solid line shows the correlation of the initial A-row stack (fuel cell stack 75a), the wide solid line shows the correlation of the initial B-row stack (fuel cell stack 75b), the narrow broken line shows the correlation of the degraded A-row stack (fuel cell stack 75a), and the wide broken line shows the correlation of the degraded B-row stack (fuel cell stack 75b).

As shown in FIG. 7A, in the initial fuel cell stacks 75a and 75b, the generated voltage and the generated electric power with respect to the same generated current do not substantially vary between the fuel cell stack 75a and the fuel cell stack 75b. However, as the degradation advances, a difference in generated voltage and a difference in generated electric power with respect to the same generated current increase between the fuel cell stack 75a and the fuel cell stack 75b. In addition, as shown in FIG. 7B, as the degradation advances, a difference in generated voltage is large when the same generated electric power is output.

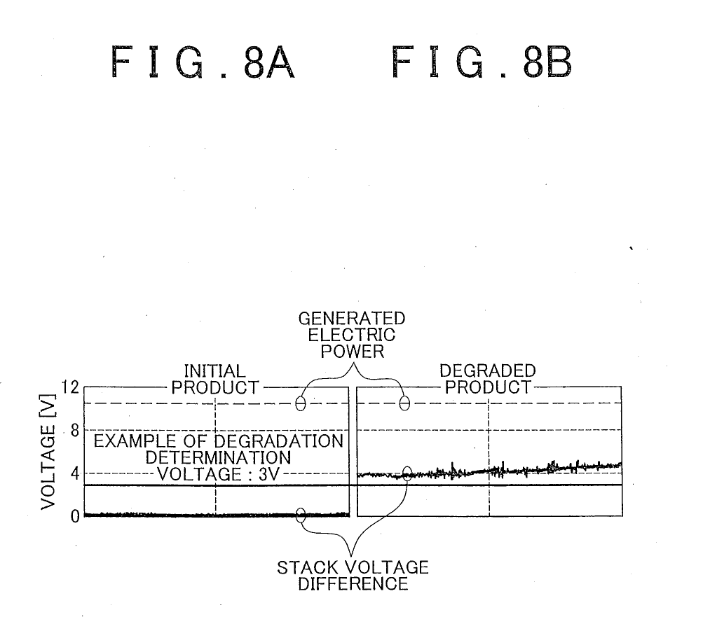

FIG. 8A is a graph that shows the electric power generated by the initial fuel cell stacks 75a and 75b over time. FIG. 8B is a graph that shows the electric power generated by the degraded fuel cell stacks 75a and 75b over time. In FIG. 8A and FIG. 8B, the abscissa axis uses the same scale of time. In addition, as shown in FIG. 8A and FIG. 8B, the total electric power generated by the fuel cell stacks 75a and 75b is maintained at substantially constant both in the initial fuel cell stacks 75a and 75b and in the degraded fuel cell stacks 75a and 75b.

As shown in FIG. 8A, there is almost no difference in generated voltage between the initial fuel cell stacks 75a and 75b. In contrast to this, as shown in FIG. 8B, there is a large difference in generated voltage between the degraded fuel cell stacks 75a and 75b.

In this way, in operation of the fuel cell system, the voltage generated by the low-temperature fuel-cell cell group (first fuel-cell cell group) deviates from the voltage generated by the high-temperature fuel-cell cell group (second fuel-cell cell group). When the rate of deviation is larger than a predetermined value, it may be determined that the fuel cell stack of which the generated voltage is low has degraded. Note that the rate of deviation (%) may be defined as follows.

{(Voltage generated by the second fuel-cell cell group)−(Voltage generated by the first fuel-cell cell group)}/(Voltage generated by the second fuel-cell cell group (or Voltage generated by the first fuel-cell cell group))×100(%)

In addition, instead of the generated voltage, the rate of deviation of the generated current or generated electric power may be used (hereinafter, the generated voltage, the generated current and the generated electric power are collectively referred to as generated output power). For example, when the same generated current is maintained, the electric power generated by the first fuel-cell cell group deviates from the electric power generated by the second fuel-cell cell group. When the rate of deviation is larger than a predetermined value, it may be determined that the fuel cell stack (fuel-cell cell group) of which the generated electric power is low has degraded. Note that the rate of deviation (%) may be defined as follows.

{(Electric power generated by the second fuel-cell cell group)−(Electric power generated by the first fuel-cell cell group}/(Electric power generated by the second fuel-cell cell group (or Electric power generated by the first fuel-cell cell group))×100(%)

In addition, when the same generated voltage is maintained, the current generated by the first fuel-cell cell group deviates from the current generated by the second fuel-cell cell group. When the rate of deviation is larger than a predetermined value, it may be determined that the fuel cell stack (fuel-cell cell group) of which the generated current is low has degraded. Note that the rate of deviation (%) may be defined as follows.

{(Current generated by the second fuel-cell cell group)−(Current generated by the first fuel-cell cell group)}/(Current generated by the second fuel-cell cell group (or Current generated by the first fuel-cell cell group))×100(%)

Note that the rate of deviation that occurs in accordance with degradation tends to be small at a low load and tends to be large at a high load. Thus, when the generated output power is large, it is desirable to increase a threshold that is used when the rate of deviation is used to determine degradation.

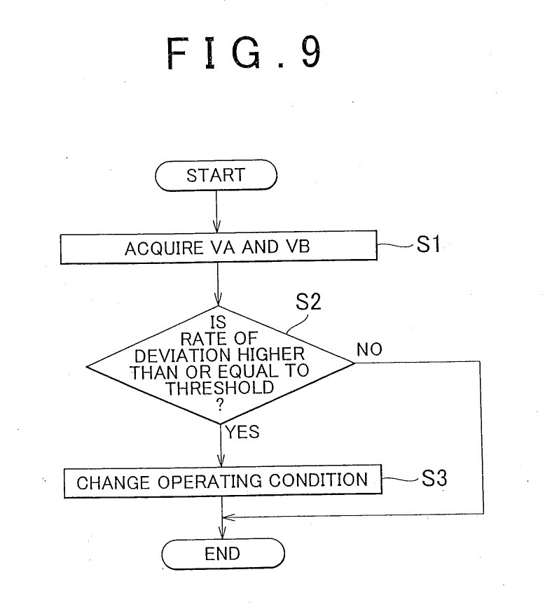

FIG. 9 is a view that shows an example of the flowchart executed when it is determined whether the fuel cell stack has degraded. The flowchart shown in FIG. 9 focuses on the rate of deviation in generated voltage. First, the CPU 12 acquires the voltage VA generated by the fuel cell stack 75a and the voltage VB generated by the fuel cell stack 75b from the voltage sensor 81 (step S1).

Subsequently, the CPU 12 determines whether the rate of deviation (%) (=(VB−VA)/VB×100(%)) is higher than or equal to a threshold (step S2). When affirmative determination is made in step S2, the CPU 12 changes the operating condition of the fuel cell stack system 70 (step S3). After that, the CPU 12 ends the flowchart. In addition, when negative determination is made in step S2 as well, the CPU 12 ends the flowchart. Note that, in the flowchart shown in FIG. 9, another type of generated output power may be used instead of the generated voltage.

According to the flowchart shown in FIG. 9, it is possible to set an appropriate operating condition in response to degradation of the fuel cell stack 75. For example, in step S3, the burning capacity in the combustion chamber 60 is increased to thereby make it possible to increase the temperature of the fuel cell stack 75a. In this case, it is possible to increase the voltage generated by the fuel cell stack 75a. Note that, in order to increase the burning capacity in the combustion chamber 60, for example, the amount of raw fuel supplied to the reformer 50 is increased to decrease the usage efficiency of the raw fuel. This is because the amount of inflammable components in the combustion chamber 60 increases.

In addition, the maximum electric power generated by the fuel cell stack system 70 may decrease as the fuel cell stack 75 degrades. Then, by decreasing the rated output power of the fuel cell stack system 70, it is possible to avoid an excessive load on the fuel cell stack system 70.

Note that, in the above example, the rate of deviation is detected from a difference between the voltage generated by the entire fuel cell stack 75a and the voltage generated by the entire fuel cell stack 75b; however, detecting the rate of deviation is not limited to this configuration. For example, the rate of deviation may be detected from a difference between the voltage generated per fuel-cell cell that constitutes the fuel cell stack 75a and the voltage generated per fuel-cell cell that constitutes the fuel cell stack 75b. This also applies to the case where the rate of deviation in generated current or generated electric power is detected.

In addition, in the above example, the fuel cell stack 75 is divide into two, that is, the relatively low temperature fuel cell stack 75a and the relatively high temperature fuel cell stack 75b; however, the aspect of the invention is not limited to this configuration. It is applicable that a group of one or more relatively low temperature fuel-cell cells 74 is set as a first fuel-cell cell group, a group of one or more relatively high temperature fuel-cell cells 74 is set as a second fuel-cell cell group and the rate of deviation is detected from a difference in generated output power between the first fuel-cell cell group and the second fuel-cell cell group.

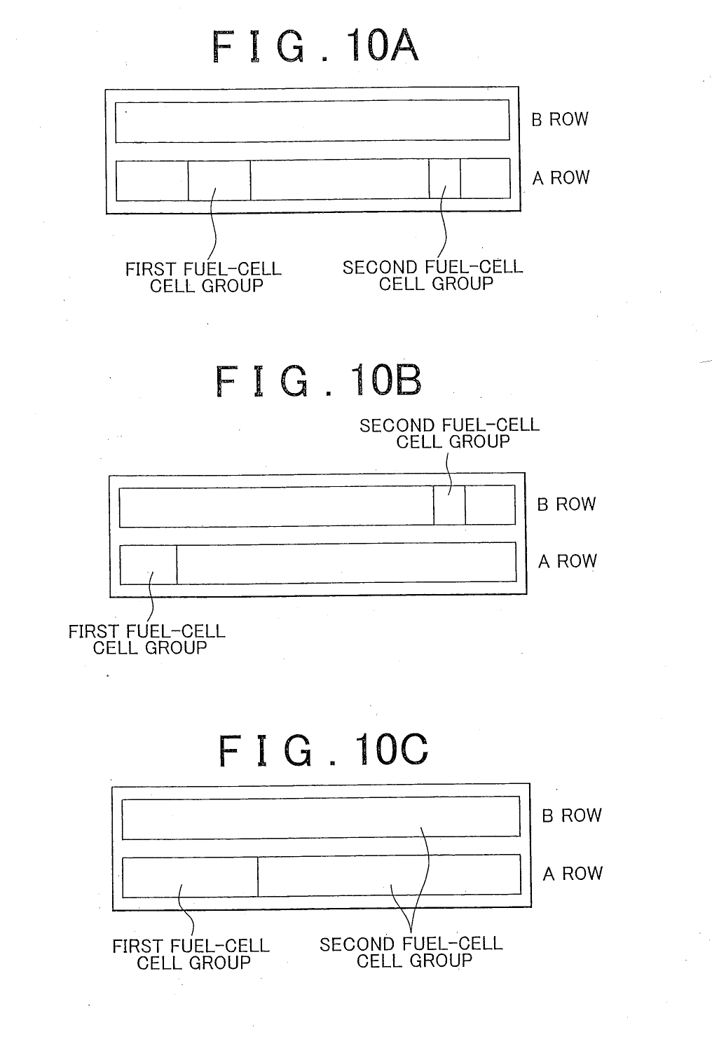

Here, as shown in FIG. 5C, the temperature of the fuel cell stack 75a is lowest near the reforming water inlet of the vaporizing portion 51 and gradually increases in the direction in which reforming water flows. This is because the amount of vaporization of reforming water is largest near the reforming water inlet of the vaporizing portion 51. Therefore, it is also applicable that, as shown in FIG. 10A, a fuel-cell cell group consisting of the fuel-cell cells 74 located near the reforming water inlet of the vaporizing portion 51 is set as a relatively low temperature first fuel-cell cell group and a fuel-cell cell group consisting of the fuel-cell cells 74 located in the other area is set as a relatively high temperature second fuel-cell cell group.

In addition, it is also applicable that, as shown in FIG. 10B, a fuel-cell cell group consisting of the fuel-cell cells 74 located in the vaporizing portion 51 is set as a relatively low temperature first fuel-cell cell group and a fuel-cell cell group consisting of the fuel-cell cells 74 located in any other area of the reforming portion 52 is set as a relatively high temperature second fuel-cell cell group. In addition, it is also applicable that, as shown in FIG. 10C, a fuel-cell cell group consisting of the fuel-cell cells 74 located in all the area of the vaporizing portion 51 is set as a relatively low temperature first fuel-cell cell group and a fuel-cell cell group consisting of the fuel-cell cells 74 located in all the area of the reforming portion 52 is set as a relatively high temperature second fuel-cell cell group.

In addition, when the first fuel-cell cell group and the second fuel-cell cell group, of which the generated voltage is detected, are defined, the hydrogen partial pressure of each fuel-cell cell 74 may be considered. Specifically, the first fuel-cell cell group and the second fuel-cell cell group may be determined so as to reduce a difference in hydrogen partial pressure between the relatively low temperature first fuel-cell cell group and the relatively high temperature second fuel-cell cell group. In this case, the power generating condition of the first fuel-cell cell group is close to the power generating condition of the second fuel-cell cell group, so the accuracy of degradation determination using the rate of deviation in generated output power improves.

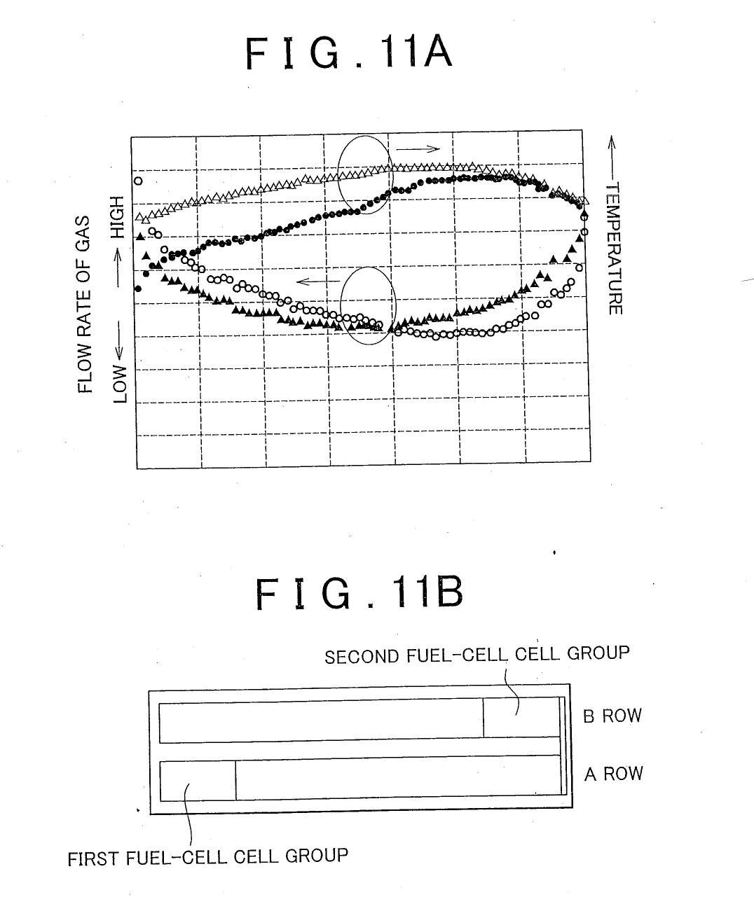

FIG. 11A is a graph that shows the calculated results of the correlation between the temperature and the flow rate of fuel gas in each of the fuel cell stacks 75a and 75b. In FIG. 11A, the abscissa axis represents the fuel-cell cells 74 in the stacking direction, the left side ordinate axis represents the flow rate of fuel gas, and the right side ordinate axis represents the temperatures of the fuel-cell cells 74. The left side of the abscissa axis indicates the reforming water inlet side of the vaporizing portion 51, and the right side of the abscissa axis indicates a side toward which reforming water flows. In FIG. 11A, the “black circle” indicates the temperature of each fuel-cell cell 74 of the fuel cell stack 75a. The “white triangle” indicates the temperature of each fuel-cell cell 74 of the fuel cell stack 75b. The “white circle” indicates the flow rate of fuel gas in each fuel-cell cell 74 of the fuel cell stack 75a. The “black triangle” indicates the flow rate of fuel gas in each fuel-cell cell 74 of the fuel cell stack 75b.

As shown in FIG. 11A, in each of the fuel cell stacks 75a and 75b, the temperature is lower at both end portions in the stacking direction than at the center portion in the stacking direction. This is due to heat radiation from both end portions. Note that the temperature is significantly low in the fuel-cell cells 74 located adjacent to the reforming water inlet of the vaporizing portion 51. On the other hand, in each of the fuel cell stacks 75a and 75b, the flow rate of fuel gas is higher at both end portions in the stacking direction than at the center portion in the stacking direction.

Then, it is also applicable that, as shown in FIG. 11B, a group of one or more fuel-cell cells 74 located adjacent to the vaporizing portion 51 of the fuel cell stack 75a is set as a first fuel-cell cell group and a group of one or more fuel-cell cells 74 located opposite to the fuel gas outlet in the fuel cell stack 75b is set as a second fuel-cell cell group. In this case, the first fuel-cell cell group is lower in temperature than the second fuel-cell cell group, and the second fuel-cell cell group is higher in temperature than the first fuel-cell cell group. In the meantime, a difference in hydrogen partial pressure between the first fuel-cell cell group and the second fuel-cell cell group reduces. Thus, the power generating condition of the first fuel-cell cell group is close to the power generating condition of the second fuel-cell cell group, so the accuracy of degradation determination using the rate of deviation in generated output power improves.

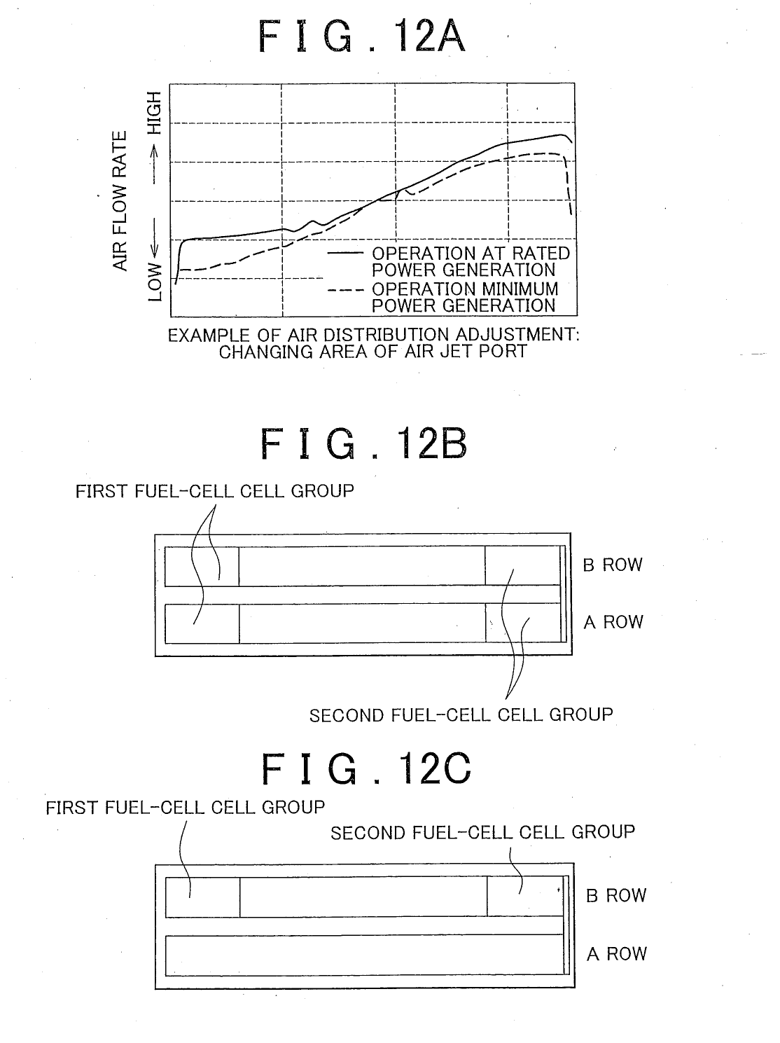

In addition, the first fuel-cell cell group and the second fuel-cell cell group, of which the generated output power is detected, may be determined on the basis of not whether the temperature is high or low but a difference in oxygen partial pressure. FIG. 12A is a graph that shows the calculated results of the flow rate of oxidant gas when rated power generation and minimum power generation are performed in each of the fuel cell stacks 75a and 75b. In FIG. 12A, the abscissa axis represents the fuel-cell cells 74 in the stacking direction, and the ordinate axis represents the flow rate of oxidant gas supplied to each fuel-cell cell 74. Note that the minimum power generation means a minimum power generation by which the fuel cell stack system 70 is able to maintain a predetermined power generation efficiency.

The distribution of oxidant gas varies depending on the structure of the oxidant gas introducing member 76, and the like. In the example of FIG. 12A, the flow rate of oxidant gas is low at a side adjacent to the vaporizing portion 51 in each of the fuel cell stacks 75a and 75b, and is high at an opposite side in each of the fuel cell stacks 75a and 75b. Then, it is also applicable that, as shown in FIG. 12B, a group of one or more fuel-cell cells 74 located adjacent to the vaporizing portion 51 of each of the fuel cell stacks 75a and 75b is set as a first fuel-cell cell group and a group of one or more fuel-cell cells 74 located opposite to the vaporizing portion 51 in each of the fuel cell stacks 75a and 75b is set as a second fuel-cell cell group. In this way, the first fuel-cell cell group and the second fuel-cell cell group each may not be necessarily continuous.

Note that, in order to avoid the influence of latent heat of vaporization in the vaporizing portion 51, it is also applicable that, as shown in FIG. 12C, a group of one or more fuel-cell cells 74 located adjacent to the vaporizing portion 51 of the fuel cell stack 75b is set as a first fuel-cell cell group and a group of one or more fuel-cell cells 74 located opposite to the vaporizing portion 51 in the fuel cell stack 75b is set as a second fuel-cell cell group.

In addition, the first fuel-cell cell group and the second fuel-cell cell group, of which the generated output power is detected, may be determined on the basis of not whether the temperature is high or low or a difference in oxygen partial pressure but a difference in hydrogen partial pressure (difference in the flow rate of fuel gas). For example, it is applicable that a fuel-cell cell group having a relatively high hydrogen partial pressure is set as a first fuel-cell cell group and a fuel-cell cell group having a hydrogen partial pressure lower than that of the first fuel-cell cell group is set as a second fuel-cell cell group.

Note that grouping into the first fuel-cell cell group and the second fuel-cell cell group based on the power generation performance factor is not limited to the above described configuration; however, in terms of difficulty in extracting a stack voltage, it is desirable that the A-row fuel cell stack 75a is set as the first fuel-cell cell group and the B-row fuel cell stack 75b is set as the second fuel-cell cell group. In this case, the first fuel-cell cell group and the second fuel-cell cell group are grouped in different rows, so it is easy to extract the voltage.

According to the present embodiment, it is possible to determine whether the fuel cell stack 75 has degraded on the basis of the rate of deviation in generated output power between the first fuel-cell cell group and the second fuel-cell cell group that are grouped on the basis of the power generation performance factor. In addition, by changing the operating condition of the fuel cell stack system 70 on the basis of the rate of deviation, it is possible to set the appropriate operating condition in response to the degradation of the fuel cell stack 75.

Next, a second embodiment of the invention will be described. It may be determined whether the fuel cell stack 75 has degraded without changing the operating condition of the fuel cell stack system 70. For example, when degradation determination is performed during periodic inspection, the fuel cell stack 75 may be replaced after inspection. In this case, power generation of the fuel cell stack system 70 may be unnecessary after degradation determination. Thus, it is only necessary to be able to determine whether replacement of the fuel cell stack 75 is required. Then, in the second embodiment, an example in which it is determined whether the fuel cell stack 75 has degraded without changing the operating condition will be described.

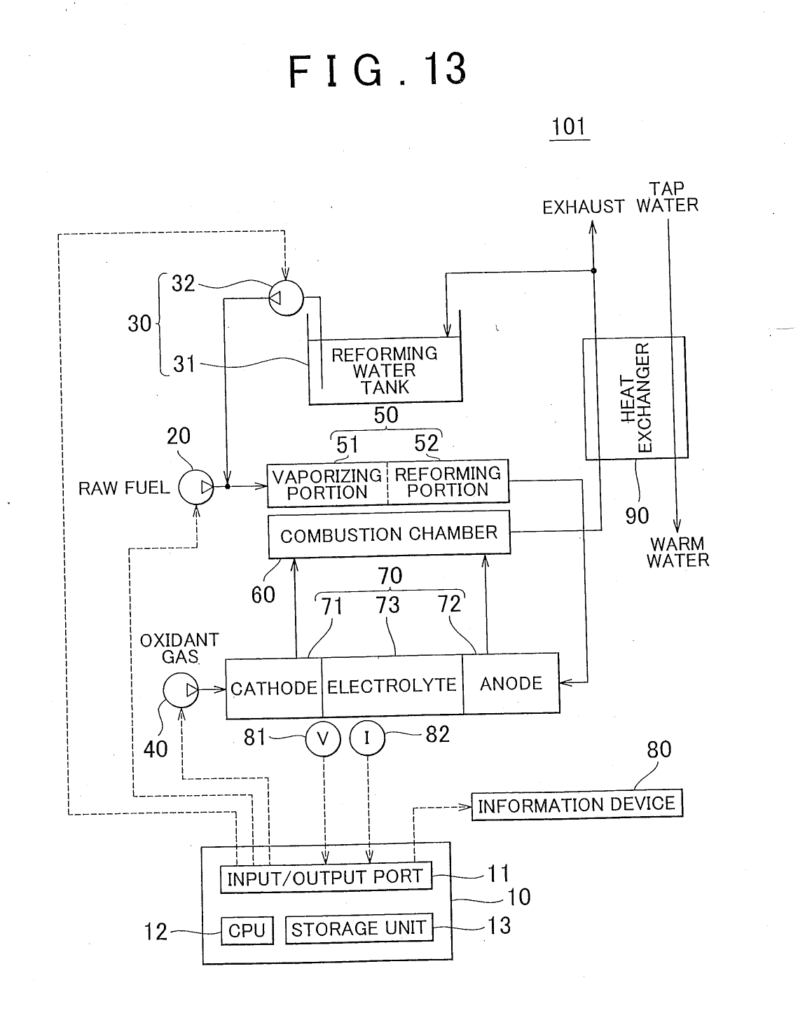

FIG. 13 is a block diagram that shows the overall configuration of a fuel cell system 101 according to the second embodiment. The fuel cell system 101 differs from the fuel cell system 100 shown in FIG. 1 in that an information device 80 is further provided. For example, when it is determined that the fuel cell stack 75 has degraded, the information device 80, for example, displays an indication or sounds an alarm that prompts a user, or the like, to carry out inspection. By so doing, replacement, or the like, of the fuel cell stack 75 may be early carried out.

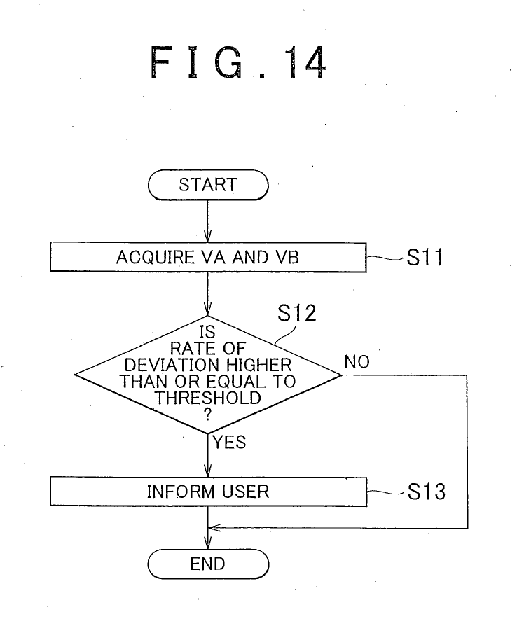

FIG. 14 is a view that shows an example of the flowchart executed when it is determined whether the fuel cell stack 75 has degraded. First, the CPU 12 acquires the voltage VA generated by the fuel cell stack 75a and the voltage VB generated by the fuel cell stack 75b from the voltage sensor 81 (step S11).

Subsequently, the CPU 12 determines whether the rate of deviation (%) (=(VB−VA)/VB×100(%)) is higher than or equal to a threshold (step S12). When affirmative determination is made in step S12, the CPU 12 causes the information device 80 to provide a notification, such as replacement of a component, to the user (step S13). After that, the CPU 12 ends the flowchart. In addition, when negative determination is made in step S12 as well, the CPU 12 ends the flowchart. According to the flowchart shown in FIG. 13, it is possible to provide appropriate information to the user in response to degradation of the fuel cell stack 75. Note that, in the flowchart shown in FIG. 14, another type of generated output power may be used instead of the generated voltage.

Note that the above embodiments may be applied to fuel cells of any types, such as a solid polymer fuel cell, a solid oxide fuel cell and a molten carbonate fuel cell. However, in a fuel cell, such as a solid oxide fuel cell, that uses high-temperature reaction gas, the power generation performance tends to change on the basis of the temperature difference. Thus, the above embodiments are particularly effective for a solid oxide fuel cell. In addition, the information device 80 according to the second embodiment may be incorporated into the first embodiment. In this case, it is possible to change the operating condition while prompting replacement of the fuel cell stack 75 in response to degradation determination.

1. A fuel cell system comprising:
a fuel cell stack that is formed of a plurality of serially connected fuel-cell cells that use fuel gas and oxidant gas to generate electric power;
a detecting unit that detects an output power generated by each of a first fuel-cell cell group and a second fuel-cell cell group that are grouped on the basis of a power generation performance factor; and
an operating condition changing unit that changes an operating condition of the fuel-cell cells on the basis of a rate of deviation between the generated output power of the first fuel-cell cell group, detected by the detecting unit, and the generated output power of the second fuel-cell cell group, detected by the detecting unit.

2. The fuel cell system according to claim 1, wherein the operating condition changing unit changes the operating condition of the fuel-cell cells when the rate of deviation is higher than or equal to a predetermined value.

3. The fuel cell system according to claim 2, wherein the predetermined value increases as an output power generated by the fuel cell stack increases.

4. The fuel cell system according to claim 1, wherein a temperature of the fuel-cell cells is used as the power generation performance factor, and the first fuel-cell cell group is relatively low in temperature as compared to the second fuel-cell cell group.

5. The fuel cell system according to claim 1, wherein a flow rate of oxidant gas supplied to the fuel-cell cells is used as the power generation performance factor, and the first fuel-cell cell group is relatively low in the flow rate of oxidant gas as compared to the second fuel-cell cell group.

6. The fuel cell system according to claim 1, wherein the generated output power is at least any one of a generated electric power, a generated current and a generated voltage.

7. The fuel cell system according to claim 1, wherein the operating condition changing unit decreases a rated output power of the fuel-cell cells when the rate of deviation is higher than or equal to a predetermined value.

8. The fuel cell system according to claim 1, further comprising a combustion chamber that burns fuel offgas exhausted from the fuel cell stack to heat the fuel cell stack, wherein
the operating condition changing unit increases an amount of fuel gas supplied to the fuel-cell cells when the rate of deviation is higher than or equal to a predetermined value.

9. The fuel cell system according to claim 1, further comprising a reformer that produces fuel gas by causing steam reforming reaction between reforming water and raw fuel, wherein
the fuel cell stack is arranged along the reformer, the first fuel-cell cell group is arranged adjacent to a reforming water inlet of the reformer, and the second fuel-cell cell group is arranged adjacent to a fuel gas outlet of the reformer with respect to the first fuel-cell cell group.

10. The fuel cell system according to claim 9, wherein the first fuel-cell cell group and the second fuel-cell cell group are arranged parallel to each other,
the reformer extends in a stacking direction of the first fuel-cell cell group, turns back and extends in a stacking direction of the second fuel-cell cell group.

11. A fuel cell system comprising:
a fuel cell stack that is formed of a plurality of serially connected fuel-cell cells that use fuel gas and oxidant gas to generate electric power;
a detecting unit that detects an output power generated by each of a first fuel-cell cell group and a second fuel-cell cell group that are grouped on the basis of a power generation performance factor; and
a degradation determining unit that determines whether the fuel cell stack has degraded on the basis of a rate of deviation between the generated output power of the first fuel-cell cell group, detected by the detecting unit, and the generated output power of the second fuel-cell cell group, detected by the detecting unit.

12. The fuel cell system according to claim 11, further comprising:
an information unit that, when the degradation determining unit determines that the fuel cell stack has degraded, informs a user of information about the degradation.

13. A control method for a fuel cell system that includes a fuel cell stack formed of a plurality of serially connected fuel-cell cells that use fuel gas and oxidant gas to generate electric power, comprising:
detecting an output power generated by each of a first fuel-cell cell group and a second fuel-cell cell group that are grouped on the basis of a power generation performance factor; and
changing an operating condition of the fuel-cell cells on the basis of a rate of deviation between the detected generated output power of the first fuel-cell cell group and the detected generated output power of the second fuel-cell cell group.

14. The control method according to claim 13, wherein the operating condition of the fuel-cell cells is changed when the rate of deviation is higher than or equal to a predetermined value.

15. The control method according to claim 14, wherein the predetermined value increases as an output power generated by the fuel cell stack increases.

16. The control method according to claim 13, wherein the first fuel-cell cell croup is relatively low in temperature as compared to the second fuel-cell cell group.

17. The control method according to claim 13, wherein a flow rate of oxidant gas supplied to the fuel-cell cells is used as the power generation performance factor, and the first fuel-cell cell group is relatively low in the flow rate of oxidant gas as compared to the second fuel-cell cell group.

18. The control method according to claim 13, wherein the generated output power is at least any one of a generated electric power, a generated current and a generated voltage.

19. The control method according to claim 13, wherein a rated output power of the fuel-cell cells is decreased when the rate of deviation is higher than or equal to a predetermined value.

20. The control method according to claim 13, wherein fuel offgas exhausted from the fuel cell stack is burned to heat the fuel cell stack, and an amount of fuel gas supplied to the fuel-cell cells is increased when the rate of deviation is higher than or equal to a predetermined value.

21. The control method according to claim 13, wherein
the fuel cell system includes a reformer that produces the fuel gas by causing steam reforming reaction between reforming water and raw fuel, and
the fuel cell stack is arranged along the reformer, the first fuel-cell cell group is arranged adjacent to a reforming water inlet of the reformer, and the second fuel-cell cell group is arranged adjacent to a fuel gas outlet of the reformer with respect to the first fuel-cell cell group.

22. The control method according to claim 21, wherein
the first fuel-cell cell group and the second fuel-cell cell group are arranged parallel to each other, and
the reformer extends in a stacking direction of the first fuel-cell cell group, turns back and extends in a stacking direction of the second fuel-cell cell group.

23. A degradation determining method for a fuel cell stack formed of a plurality of serially connected fuel-cell cells that use fuel gas and oxidant gas to generate electric power, comprising:
detecting an output power generated by each of a first fuel-cell cell group and a second fuel-cell cell group that are grouped on the basis of a power generation performance factor; and
determining whether the fuel cell stack has degraded on the basis of a rate of deviation between the detected generated output power of the first fuel-cell cell group and the detected generated output power of the second fuel-cell cell group.

24. The degradation determining method according to claim 23, further comprising:
when it is determined that the fuel cell stack has degraded, informing a user of information about the degradation.
